(19) United States
(12) Patent Application Publication
(10) Pub. No.: US 2026/0160073 A1
(43) Pub. Date: Jun. 11, 2026

(54) DEVICE FOR ATTACHING A CLADDING PANEL TO A STRUCTURE

(71) Applicant: SB INGENIERIE, POISY (FR)

(72) Inventors: Sylvianne GIACOMETTI, CHOISY (FR); Romain CHAPEL, SAINT SYLVESTRE (FR)

(21) Appl. No.: 18/705,870

(22) PCT Filed: Oct. 26, 2022
(86) PCT No.: PCT/EP2022/080016

§ 371 Date: Apr. 29, 2024

(30) Foreign Application Priority Data
Oct. 29, 2021 (FR) 2111549

(51) Int. Cl. E04F 13/08; E04F 13/14; F16B 5/06

(52) U.S. Cl. CPC E04F 13/083; E04F 13/145; F16B 5/0685

(57) ABSTRACT

A device (20) for fastening a cladding panel (12) includes a crosspiece (22) including a hooking edge (30) and a hook (34) intended to be hooked to the crosspiece (22) by a first approach movement longitudinally rearwards, and then by a second hooking movement by vertical sliding downwards according to a hooking direction. A means is provided for blocking sliding of the hook (34) in a release direction, where the blocking means include a blocking element (56) which is movably mounted on a body (36) of the hook (34) between a release position and a blocking position towards which it is elastically biased.

### TECHNICAL FIELD OF THE INVENTION

The invention relates to a device for fastening a vertical cladding panel, in particular a glass panel, on a structure, the fastening device including:
a crosspiece intended to be fastened on the structure and including a hooking edge;
a hook intended to be hooked to the crosspiece by a first approach movement during which the hook is brought close to the crosspiece, longitudinally rearwards, above the edge, and then by a second hooking movement by sliding vertically downwards according to a hooking direction, the hook including means for fastening on a rear face of the panel;
means for blocking the upward sliding of the hook in an unhooking direction when it is hooked to the crosspiece.

### TECHNICAL BACKGROUND

It is known to fasten a transverse vertical cladding panel on a structure using a fastening device.

In known manner, the fastening device includes a support which is secured to the structure and a hook which is secured to the panel. The hook is hooked on the support so as to position the panel on the structure.

To prevent unhooking of the panels, solutions by tightening the hook relative to the support are known, for example by inserting corners using a hammer or by longitudinal tightening of a notched plate against a vertical face of the hook.

These solutions are not satisfactory because they require sufficient tightening of the locking element against the hook. Without sufficient tightening, the panel is at risk of being unhooked. Furthermore, these solutions require the use of tools at the rear of the panel after installation thereof, often blindly, in very restricted accessibility conditions.

Hence, there is a need to find a fastening solution which allows preventing unhooking of a transverse vertical panel from to its fastening structure, and which is easy and quick to assemble.

### SUMMARY OF THE INVENTION

The invention proposes a device for fastening a vertical cladding panel, in particular a glass panel, including:
a crosspiece including a hooking edge;
a hook intended to be hooked to the crosspiece by a first approach movement during which the hook is brought close to the crosspiece, longitudinally rearwards, above the edge, and then by a second hooking movement by vertical sliding downwards according to a hooking direction, the hook including means for fastening on a rear face of the panel;
means for blocking the upward sliding of the hook in an unhooking direction when it is hooked to the crosspiece.

The fastening device according to the invention is characterized in that the blocking means include a blocking element which is movably mounted on a body of the hook between:
a release position towards which it is longitudinally pushed rearwards automatically by contact with the crosspiece during the approach movement;
a blocking position towards which it is elastically biased forwards and in which the blocking element is intended to be fitted under a stop face of the crosspiece at the end of the hooking movement to prevent unhooking of the hook.

According to another aspect of the fastening device of the invention, the blocking element is pivotally mounted on the hook via an elastic return member, the blocking element being clamped vertically against the stop face when the hook is mounted on the crosspiece.

According to another aspect of the fastening device of the invention, the elastic return member is formed by an asymmetrical wire spring including two tabs with different lengths, each of which includes one end for connection with the blocking element and a free end pivotally mounted around a transverse pivot axis in the body of the hook, the pivot axes of each tab being distinct.

According to another aspect of the fastening device of the invention, the blocking element is formed by the folded section of a spring wire, two end sections of which form the two tabs of the elastic return member.

According to another aspect of the fastening device of the invention, the elastic return element includes a pusher which is accessible to the finger of a user when the hook is hooked to the crosspiece and which, through a lever effect, allows manually controlling the blocking element towards its release position against the elastic return force.

According to another aspect of the fastening device of the invention, the pusher is formed by a section of the spring wire forming the blocking element.

According to another aspect of the fastening device of the invention, the means for fastening the hook on the panel include a flange for contact with the panel which is linked to the body of the hook with an angular travel around a longitudinal axis.

According to another aspect of the fastening device of the invention, the flange is mounted in the body of the hook via a cylindrical spacer with a longitudinal axis pivotally received in an orifice of the hook, a pin being fastened across the spacer through an aperture of the body opening transversely into the orifice, two opposite edges of the aperture defining travel stops by contact with the pin during pivoting of the flange.

According to another aspect of the fastening device of the invention, it includes a clip for transversely immobilizing the hook relative to the crosspiece, the clip being intended to be fastened at least transversely on the crosspiece.

The invention also proposes an assembly comprising a cladding panel, and at least one fastening device made according to the teachings of the invention which includes at least two hooks which are arranged along an upper edge of the panel, against a rear face of the panel, the two hooks being intended to be hooked on the same crosspiece.

According to another aspect of the assembly made according to the teachings of the invention, only one amongst the hooks of the fastening device includes a clip for transversely immobilizing the hook relative to the crosspiece, the other one amongst said hooks being configured to be hooked to the associated crosspiece free to slide according to a transverse direction.

### BRIEF DESCRIPTION OF THE FIGURES

Other features and advantages of the invention will appear upon reading of the following detailed description, for the understanding of which reference will be made to the appended drawings which are briefly described hereinbelow.

FIG. 1 is a perspective view of a structure on which cladding panels are fastened by means of fastening devices made according to the teachings of the invention.

FIG. 2 is a perspective view of the rear of a cladding panel which is provided with two upper hooks made according to the teachings of the invention.

FIG. 3 is a side view which shows a hook of the fastening device made according to the teachings of the invention located at a distance from a crosspiece of said fastening device.

FIG. 4 is a view similar to that of FIG. 1 which only shows the structure equipped with several crosspieces identical to that of FIG. 3.

FIG. 5 is a view similar to that of FIG. 3 which shows the hook in a position hooked to the crosspiece.

FIG. 6 is a perspective view which shows the front of the hook of FIGS. 3 and 5.

FIG. 7 is a perspective view which shows the rear of the hook of FIG. 6.

FIG. 8 is a view similar to those of FIGS. 3 and 5 which shows the hook in an approached position abutting against the crosspiece.

FIG. 9 is an exploded side view which shows the means of fastening the hook to the panel.

FIG. 10 is a perspective view which shows the hook in the hooked position on the crosspiece, and a first embodiment of a clip intended to immobilize the transverse sliding of the hook in the crosspiece.

FIG. 11 is a view similar to that of FIG. 10 in which the clip is placed in position on the hook.

FIG. 12 is a perspective view which shows the hook in the hooked position on the crosspiece, and a second embodiment of a clip intended to immobilize the transverse sliding of the hook in the crosspiece.

FIG. 13 is a view similar to that of FIG. 12 in which the clip is placed in position on the hook.

### DESCRIPTION OF THE INVENTION

In the remainder of the description, elements having an identical structure or similar functions will be designated by the same reference.

In the remainder of the description, we will adopt without limitation a longitudinal orientation “L”y, directed orthogonally to the plane of the panel, from the rear towards the front, a vertical orientation “V” directed from top to bottom and a transverse orientation “T” directed from left to right.

The vertical orientation “V” is herein directed generally according to the direction of Earth's gravity.

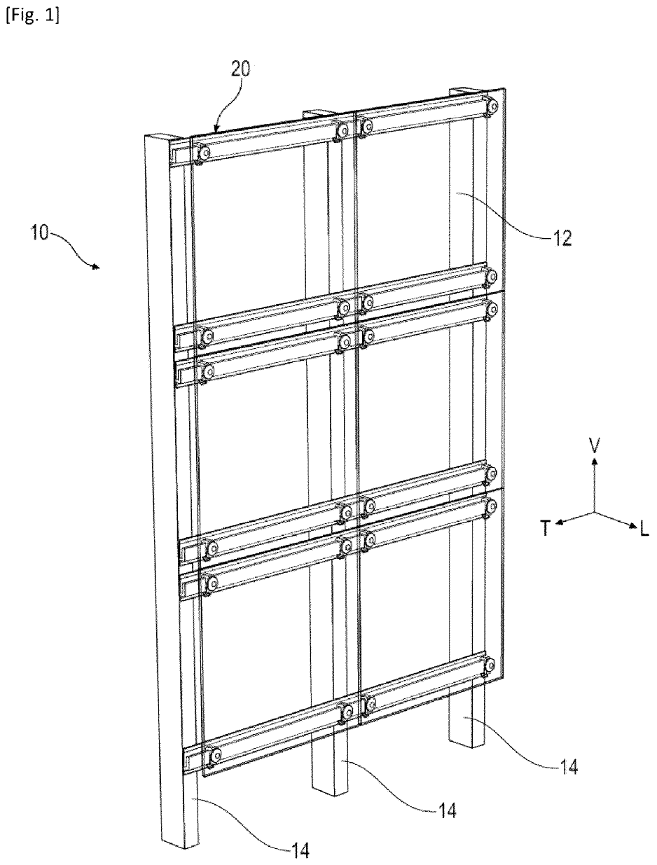

FIG. 1 shows a vertical structure 10 on which cladding panels 12 are fastened.

The vertical structure 10 is herein formed of vertical uprights 14 which are arranged parallel to one another at a distance according to a transverse direction. For example, the uprights 14 are fastened to a wall such as a facade of a building or an external wall. The uprights may be fastened either in contact with the wall or at a distance from the wall.

Alternatively, the structure is formed directly by a wall such as a facade or an external wall.

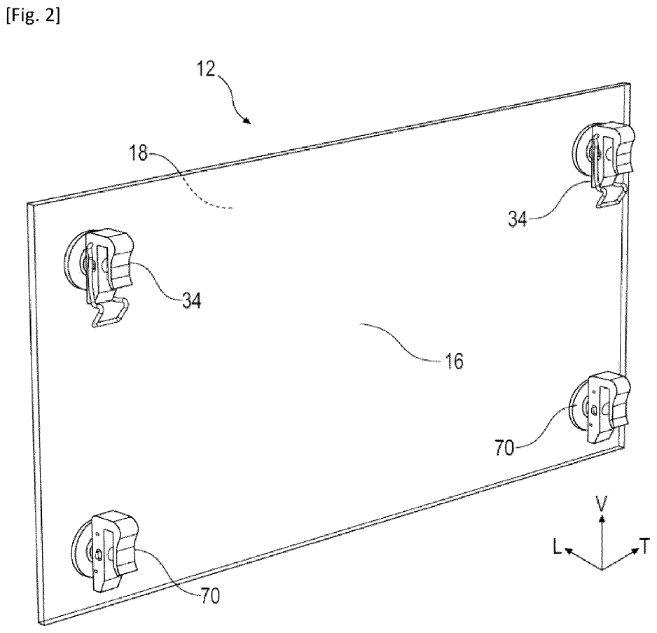

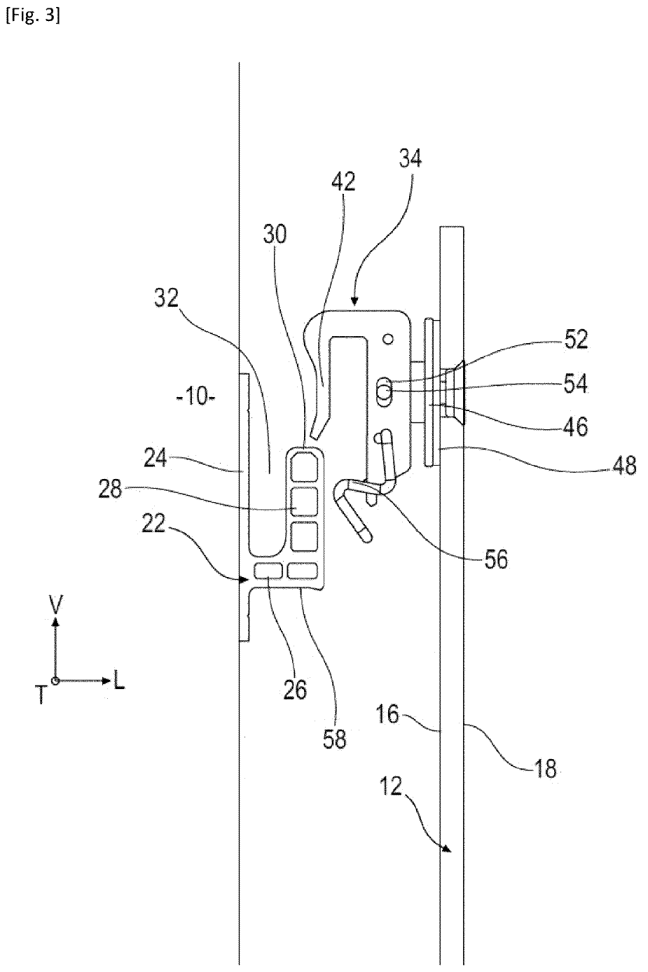

As shown in FIGS. 2 and 3, each cladding panel 12 herein has a rectangular shape. For example, these consist of glass panels. The glass panel may possibly integrate photovoltaic cells to form a solar panel. Each cladding panel 12 extends in a vertical transverse plane. Each cladding panel 12 is delimited longitudinally by a rear face 16, facing the structure 10 and a front face 18 opposite to the rear face 16. These consist of large cladding panels 12, for example more than 1 m high. Such cladding panels 12 also have a very heavy weight, for example in the range of 300 kg.

Each cladding panel 12 is fastened to the structure 10 via at least one fastening device 20.

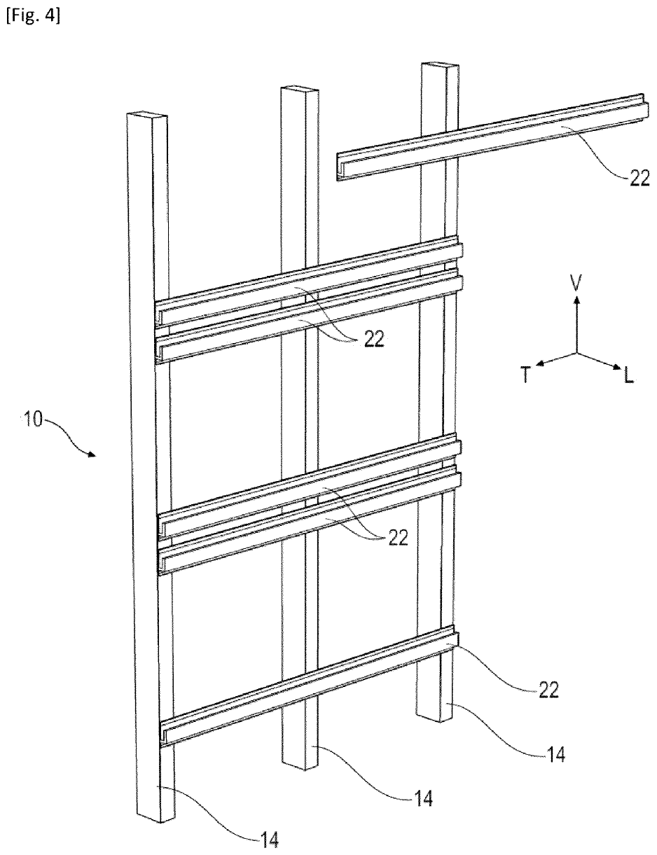

As shown in FIG. 4, such a fastening device 20 includes a crosspiece 22 intended to be fastened on the structure 10. The crosspiece 22 extends according to a main transverse axis perpendicular to the uprights 14. The crosspiece 22 is fastened to at least two uprights 14 by two free end sections so as to extend transversely between the two uprights 14.

Because of the presence of these uprights 14, it is possible to interpose a layer of an insulating material (not shown) between the crosspieces 22 and the wall to which the uprights 14 are fastened.

Alternatively, when the structure is formed by a wall, the crosspieces 22 are fastened directly in contact with the wall.

The crosspieces 22 are herein arranged in vertical columns. When it is desired that all of the cladding panels 12 are aligned transversely, the crosspieces 22 of two adjacent columns are aligned transversely. When, on the contrary, it is desired to arrange the panels in a staggered manner, the crosspieces 22 of a column are offset vertically relative to the crosspieces 22 of the adjacent columns.

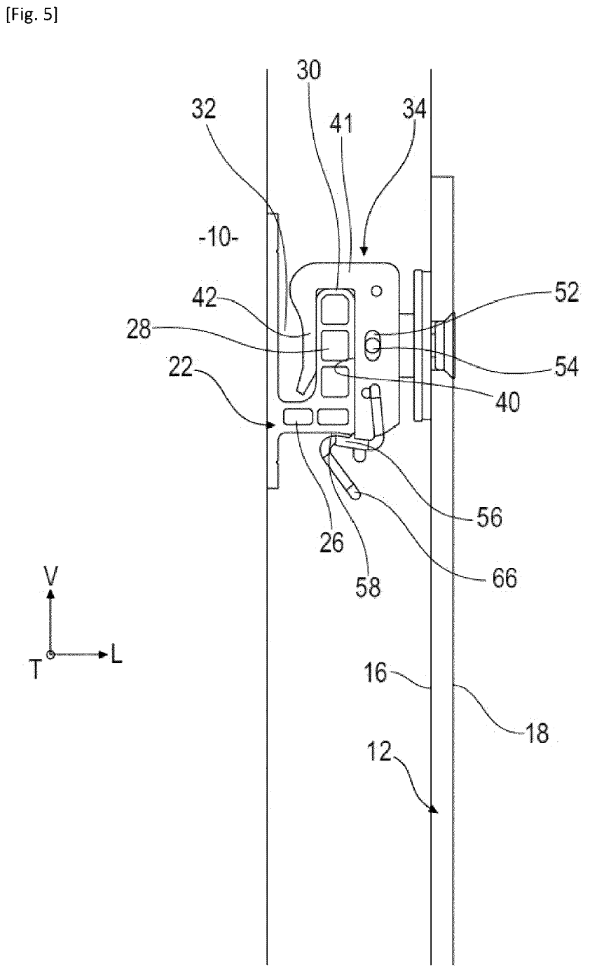

The crosspiece 22 is in the form of a profile whose section is shown in detail in FIGS. 3 and 5. Thus, the crosspiece 22 has a sole 24 in the form of a vertical plate. The sole 24 has a rear face which is intended to be pressed against the structure 10, herein formed of uprights 14 to enable fastening thereof, for example by screwing.

The section of the crosspiece 22 also includes a core 26 which extends longitudinally projecting relative to a front face of the sole 24. A wing 28 extends vertically upwards from a front end edge of the core 26. The wing 28 is delimited upwards by a free end edge 30. The free end edge 30 will subsequently be called “hooking edge 30”.

The wing 28, the core 26 and the sole 24 define a groove 32 open upwards.

The fastening device 20 includes at least one hook 34. The fastening device 20 herein includes two hooks 34 which are arranged at two upper corners of the rear face 16 of the panel 12, as shown in FIG. 2. The two hooks 34 being identical, only one of these hooks 34 will be described later on.

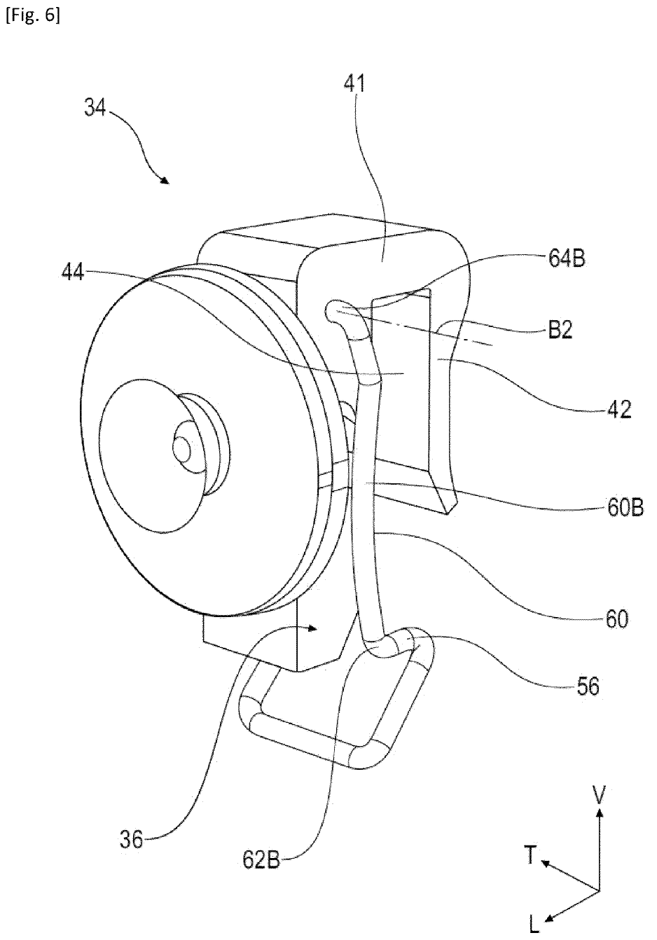

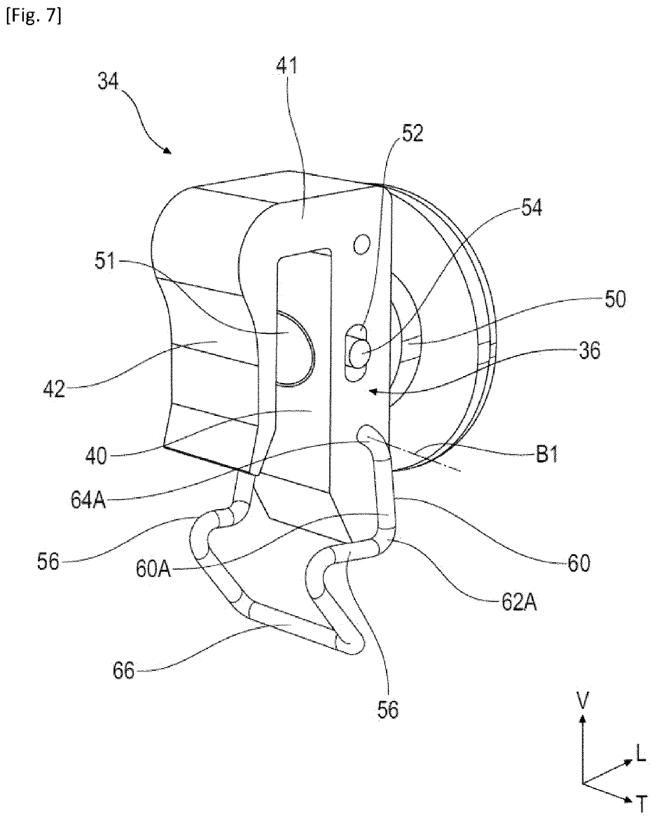

As shown in FIGS. 6 and 7, the hook 34 includes a body 36 which extends according to a main vertical direction. The body 36 has a front face 38 which is intended to be arranged opposite the rear face 16 of the panel 12, as illustrated in FIG. 5. Moreover, the body 36 has a transverse vertical rear face 40. The body 36 has at its upper end an arm 41 which extends at right angles longitudinally rearwards. A wing 42 extends vertically downwards from a rear end of the arm 41. A front face 44 of the wing 42 is arranged opposite the rear face 40 of the body 36. Thus, the wing 42, the body 36 and the arm 41 delimit the interior of the hook 34.

A free lower end of the wing 42 is located above the level of the lower end of the body 36 so that a lower portion of the rear face 40 of the body projects vertically downwards relative to the wing 42.

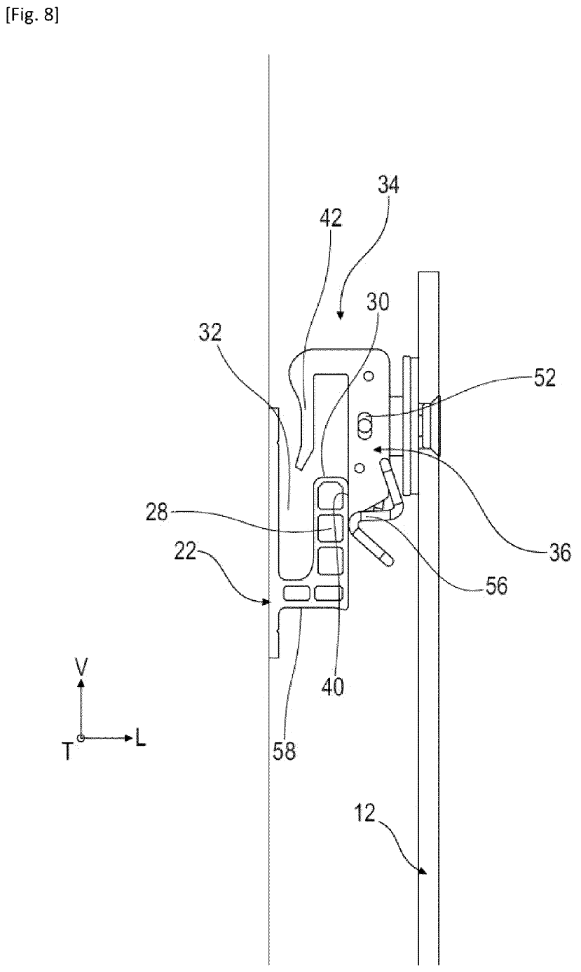

Thus, the hook 34 is intended to be hooked to the crosspiece 22 by a first approach movement during which the hook 34 is brought close to the crosspiece 22 by translation according to a longitudinal approach direction directed rearwards, passing from the position shown in FIG. 3 into the position shown in FIG. 8. During this approach movement, the lower end of the wing 42 passes above the hooking edge 30 of the crosspiece 22 until the wing 42 is arranged directly above the groove 32. In this position, the lower portion of the rear face 40 of the body 36 abuts against the front face of the wing 28 of the crosspiece 22. Then, in a second hooking movement, the hook 34 is slid vertically downwards according to a hooking direction so that the wing 42 of the hook 34 is received in the groove 32, passing from the position shown in FIG. 8 into the position indicated in FIG. 5. The hooking movement continues until the arm 41 bears on the hooking edge 30 of the crosspiece 22 to hang the panel 12. The hooking movement is guided by the sliding contact between the rear face 40 of the body 36 and the front face of the wing 28 of the crosspiece 22.

Furthermore, to ensure that the hooking edge 30 is well received in the hook 34, between the wing 42 and the body 36, the wing 42 includes at its lower end a section slightly curved towards the rear to form a guide ramp of the hooking edge 30. Similarly, the rear face 40 of the body 36 includes a beveled lower end to guide the hooking edge 30 between the wing 42 and the body 36 of the hook 34.

The hook 34 also includes means for fastening on the rear face 16 of the panel 12.

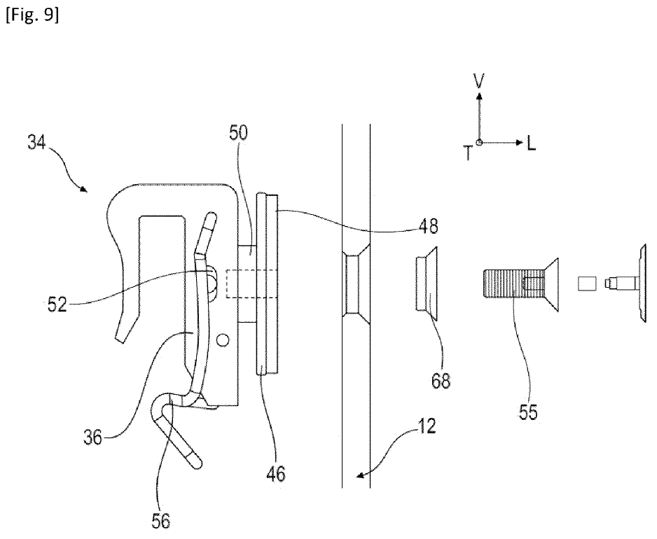

As a non-limiting example shown in FIG. 9, in the embodiment shown in the figures, the means for fastening the hook 34 include a flange 46 for contact with the rear face 16 of the panel 12. The flange 46 is herein in the form of a longitudinal axis disc, one front face of which is lined with a buffer 48, for example made of an elastomeric material, to avoid damaging the glass panel 12.

Advantageously, yet not necessarily, the flange 46 is mounted in the body 36 of the hook 34 with an angular travel around its longitudinal axis. In particular, this allows compensating for a defect in the verticality of the crosspiece 22 in order to guarantee that all of the hooks 34 of the panel 12 are properly hooked to the crosspiece 22.

In the embodiment shown in FIGS. 7 and 9, the flange 46 is mounted in the body 36 of the hook 34 via a cylindrical spacer 50 with a longitudinal axis pivotally received around said axis in an orifice with complementary shape which opens into the front face 38 of the body 36. The spacer 50 herein includes a central stud 51 at the rear end to be inserted into the associated orifice of the body 36 to properly position the spacer 50 according to a longitudinal direction by abutting against a shoulder face of the orifice of the body 36. The body 36 includes at least one opening 52 which opens transversely into one of its vertical lateral edges. The aperture opens transversely into the orifice of the body 36. The aperture 52 has an oblong shape elongated vertically and limited vertically by two end edges, as is particularly visible in FIGS. 5 and 7.

A pin 54 is fastened across the spacer 50 so that the pin 54 projects through the associated aperture 52 of the body 36. Thus, the pin 54 is pivotally secured to the cylinder around the longitudinal axis. The two vertical end edges of the aperture define travel stops by contact with the pin 54 during pivoting of the flange 46 relative to the hook 34.

As shown in FIG. 9, the hook 34 is herein fastened to the panel via a screw 55 which is intended to be screwed into a central thread (not shown) of the spacer 50 which opens into the front face of the flange 46.

According to the teachings of the invention, the hook 34 includes means for blocking sliding upwards in an unhooking direction when it is hooked to the crosspiece 22. The blocking means include a blocking element 56 which is movably mounted on the body 36 of the hook between:
a release position towards which it is longitudinally pushed rearwards automatically by contact with the crosspiece 22 during the approach movement, as shown in FIG. 8; and
a blocking position towards which it is elastically biased forwards and in which the blocking element 56 is intended to be fitted under a stop face 58 of the crosspiece 22 at the end of the hooking movement to prevent unhooking of the hook 34, as shown in FIG. 5.

To enable the blocking element 56 to be automatically pushed towards its release position, the blocking element 56 is arranged so as to project rearwards relative to the rear face 40 of the body 36 when it occupies its blocking position, as shown in FIG. 5.

More particularly, the stop face 58 is herein formed by a lower face of the core 26 of the crosspiece 22.

Preferably, the blocking element 56 is arranged to the right of the hook portion 34 which bears on the hooking edge 30, when the hook 34 is mounted on the crosspiece 34.

The blocking element 56 is herein pivotally mounted on the body 36 of the hook 34 via an elastic return member 60 which allows providing the elastic return force towards its blocking position. This elastic return member 60 also allows tightening the blocking element 56 vertically against the stop face 58 when the hook 34 is mounted on the crosspiece 22.

More particularly, the blocking element 56 is pivotally mounted around a generally transverse pivot axis which is herein located above the blocking element 56. In its release position, the locking element 56 is arranged below the body 36 of the hook so as to clear access from the edge 34 to the inside of the hook 34, and in the blocking position, the blocking element 56 is located in front of the body 36 of the hook 34, above its release position.

In the blocking position, the blocking element 56 is more particularly arranged to the right of its pivot axis so that a vertical force applied to the blocking element 56 does not cause any movement of the latter.

As shown in FIGS. 6 and 7, the elastic return member 60 is herein formed by an asymmetrical wire spring including two tabs 60A, 60B with different lengths, each of which has one end 62A, 62B for connection with the blocking element 56 and a free end 64A, 64B pivotally mounted around a transverse pivot axis “B1, B2” fastened in the body 36 of the hook 34. The connecting ends 62A, 62B of the tabs 60A, 60B are arranged substantially at the same height.

For example, the free end 64A, 64B of the tabs 60A, 60B is curved orthogonally to the tab towards the body 36 to be inserted into corresponding holes.

Each tab 60A, 60B herein extends generally vertically when the blocking element 56 occupies its blocking position. The connecting ends 62A, 62B form lower ends of the tabs 60A, 60B, whereas the free ends 64A, 64B herein consist of upper ends of the tabs 60A, 60B. The pivot axes “B1, B2” of each tab 60A, 60B are distinct. They are herein vertically offset due to the difference in length of the two tabs 60A, 60B. The pivot axis of the blocking element 56 is then located generally between the two axes “B1, B2”.

This offset of the pivot axes “B1, B2” combined with the elasticity of the wire causes elastic bending of the tabs 60A, 60B when the blocking element 56 is pushed towards its release position. The tabs 60A, 60B are then returned towards their vertical position by their own elasticity.

As a not shown variant of the invention, the elastic return member may also be made by other means. For example, the elastic return member is made by a torsion spring or by an elastically-flexible leaf spring.

Advantageously, the blocking element 56 and the elastic return member 60 are made in one-piece.

In the example shown in the figures, the blocking element 56 is herein formed by the folded section of a spring wire, two end sections of which form the two tabs 60A, 60B of the elastic return member 60. For example, the blocking element 56 is made by folding the wire forming each tab 60A, 60B rearwards.

In some cases, it may be advantageous to be able to unhook the hook 34 in a simple manner, for example to be able to replace a defective panel 12. To this end, the elastic return element 56 also includes a pusher 66 which is accessible to the finger of a user when the hook 34 is hooked to the crosspiece 22. Through a lever effect, this pusher 66 allows manually controlling the blocking element 56 towards its release position against the elastic return force.

To increase the lever effect, the pusher 66 is herein arranged below the blocking element 56. The pusher 66 is more particularly carried by the blocking element 56, as shown in FIGS. 5 and 7.

Advantageously, the pusher 66 is formed by a section of the spring wire forming the blocking element 56.

Thus, the elastic return member 60, the blocking element 56 and the pusher 66 are herein made by folding the same spring wire. The spring wire includes two end sections forming the tabs 60A, 60B. Afterwards, a section is folded rearwards at the base of the legs 60A, 60B to form the blocking element 56. A wire section located at the rear of the blocking element 56 is bent forwards below the blocking element 56 to form the pusher 66.

To mount the panel 12 on a structure 10, the crosspiece 22 is first fastened to the uprights 14, as shown in FIG. 4.

Then, at least two hooks 34 are mounted proximate to each upper corner of panel 12. These two hooks 34 are intended to be hooked on the same crosspiece 22.

Panel 12 is herein pierced with two holes. Each hook 34 is arranged so that its flange 46 is flat against the rear face 16 of the panel 12, the central thread coinciding with an associated hole in the panel 12. Afterwards, the screw 55 is inserted into the thread throughout the hole. The head of the screw 55 is tightened against the front face 16 of the panel 12, preferably with interposition of a washer 68 to allow distributing the tightening forces over the entire periphery of the hole, as shown in FIG. 9. Thus, both hooks 34 are fastened to the panel 12.

As shown in FIG. 2, the lower corners of the panel 12 are herein provided with hooks 70 which have the same structure as the previously described hooks 34, except that they do not include means for preventing detachment thereof. These hooks 70 are intended to be hooked to a crosspiece 22 identical to that of the previously-described fastening device. During hooking, the panel 12 is positioned parallel to the crosspieces 22, at a distance from the structure 10, as shown in FIG. 3. Then, the first approach movement is carried out according to the approach direction until the rear face 40 of the body 36 of the hooks 34 is in contact with the front face of the wing 28 of the crosspiece 22, as shown in FIG. 8. During this movement, a rear end of the blocking element 56 abuts against the front face of the wing 28 of the crosspiece 22, which causes movement thereof rearwards into its release position against the elastic return force of the elastic return member 60.

Then, during the hanging movement, the panel is slid downwards according to the hooking direction. The hooks 34 then hook to the hooking edge 30 of the crosspiece 22, as shown in FIG. 5. The hooks 34 then bear on the crosspiece 22 against the weight of the panel 12.

In doing so, the blocking element 56 also slides downwards and when it arrives below the core 26, it is elastically biased towards its blocking position in which it is tightened against the stop face 58, below the core 26.

When an unhooking force is applied to the panel, the blocking element 56 abuts against the stop face 58 to prevent the panel 12 from moving. The unhooking force is transmitted to the body 36 of the hook 34 via the vertical tabs 60A, 60B without causing any movement of the blocking element 56.

The lower hooks 70 are also hooked to their crosspiece 22 in the same way and in the same movement of the panel 12. However, the lower hooks 70 do not bear on their crosspiece 22 to enable a vertical expansion of the panel 22.

In this position, the panel 12 is still capable of sliding transversely in the groove 32 of the crosspiece 22.

To block this last degree of freedom of the panel 12, a clip 72 is provided for which is intended to be arranged on one of the upper hooks 34. The clip 72 includes two legs 74 connected by a transverse bridge 76. The two legs 74 are arranged transversely on either side of the hook 34, for example by interlocking vertically downwards.

The clip 72 further includes means for immobilization at least transversely with respect to the crosspiece 22.

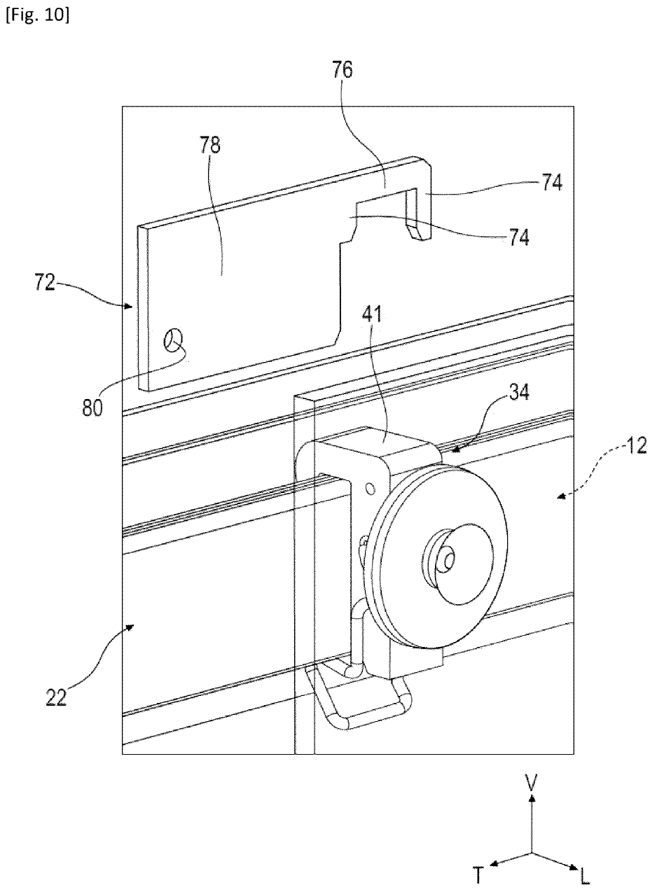

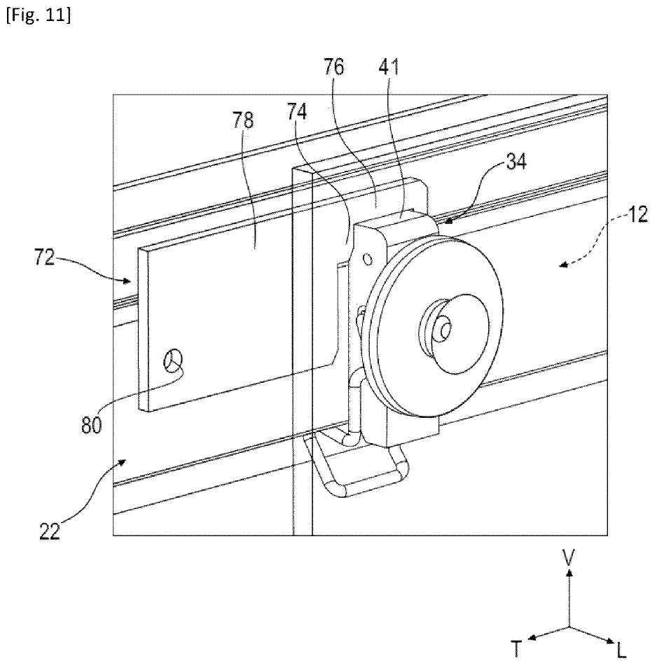

According to a first embodiment of the clip 72 shown in FIGS. 10 and 11, the immobilization means are formed by a plate 78 which is fastened to the clip 72. For example, the plate 78 is made in one-piece with the clip 72. This plate 78 includes a fastening orifice 80 which is intended to be arranged against one face of the crosspiece 22 when the clip 72 is fitted around the hook 34. The plate 78 is then fastened to the crosspiece by means of a screw (not shown) through the fastening orifice 80. This arrangement allows blocking the transverse movement of panel 12. Furthermore, the plate 78 is designed to extend beyond the edge of the panel 12 according to a transverse direction to enable fastening thereof by screwing after installation of the panel 12.

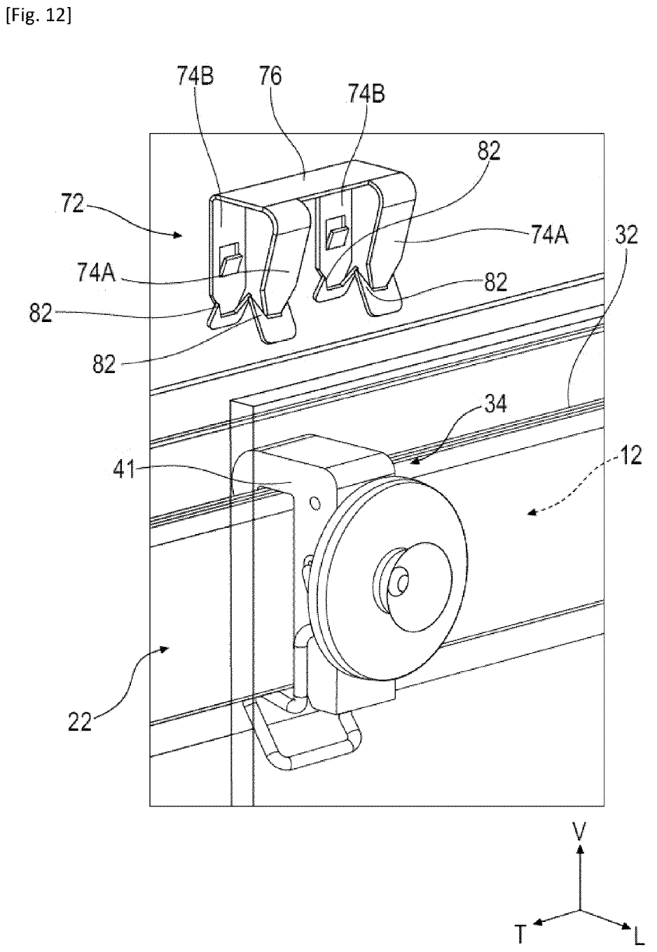

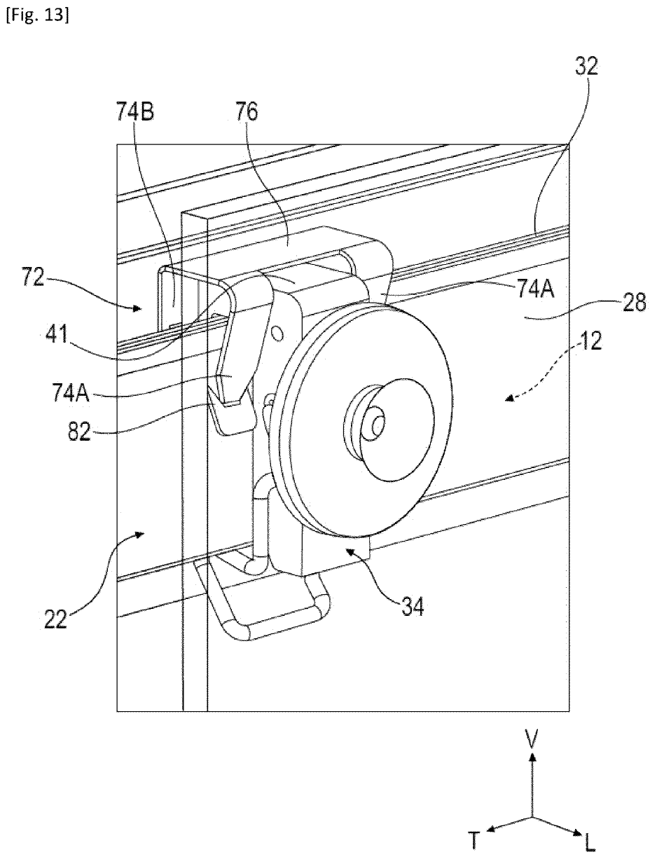

According to a second embodiment of the clip 72 shown in FIGS. 12 and 13, the immobilization means consist of pinching means. The clip 72 is then provided with two pairs of legs 74A, 74B on either side of the hook 34. Each pair includes a front leg 74A and a rear leg 74B. The legs 74A, 74B of each pair are arranged longitudinally opposite one another and they are elastically biased towards one another according to a longitudinal direction. Each leg 74A, 74B of a pair is provided with at least one spur 82 which is directed towards the other leg 74A, 74B of the pair.

When the jumper 72 is fitted onto the hook 34, the rear leg 74B of each pair is received inside the groove 32, while the front leg 74A is received against the front face of the wing 28 of the crosspiece 22, outside of groove 32. The two legs 74A, 74B each then enclose the wing 28 of the crosspiece 22 so that their spurs 82 bite into the material constituting the crosspiece 22. The spurs 82 thus make it possible to fix the jumper 72 to the crosspiece 22.

1. A device for fastening a vertical cladding panel, in particular a glass panel, comprising:
a crosspiece including a hooking edge;
a hook intended to be hooked to the crosspiece by a first approach movement during which the hook is brought close to the crosspiece, longitudinally rearwards, above the edge, and then by a second hooking movement by sliding vertically downwards in a hooking direction, the hook including means for fastening on a rear face of the panel;
means for blocking the upward sliding of the hook in an unhooking direction when it is hooked to the crosspiece;
wherein the blocking means include a blocking element which is movably mounted on a body of the hook between:
a release position towards which it is automatically pushed longitudinally rearwards by contact with the crosspiece during the approach movement;
a blocking position towards which it is elastically biased forwards and in which the blocking element is intended to be fitted under an abutment face of the crosspiece at the end of the hooking movement to prevent the hook from being unhooked.

2. The fastening device according to claim 1, wherein the blocking element is pivotally mounted on the hook via an elastic return member, the blocking element being clamped vertically against the abutment face when the hook is mounted on the crosspiece.

3. The fastening device according to claim 2, wherein the elastic return member is formed by an asymmetrical wire spring including two tabs with different lengths, each of which includes one end for connection with the blocking element and a free end pivotally mounted around a transverse pivot axis in the body of the hook, the pivot axes of each tab being separate.

4. The device according to claim 3, wherein the blocking element is formed by the folded section of a spring wire, two end sections of which form the two tabs of the elastic return member.

5. The device according to claim 1, wherein the elastic return element includes a pusher which is accessible to the finger of a user when the hook is hooked to the crosspiece and which, through a lever effect, allows manually controlling the blocking element towards its release position against the elastic return force.

6. The device according to claim 5,
wherein the blocking element is formed by the folded section of a spring wire, two end sections of which form the two tabs of the elastic return member, and
wherein the pusher is formed by a section of the spring wire forming the blocking element.

7. The device according to claim 1, wherein the means for fastening the hook on the panel include a flange for contact with the panel which is linked to the body of the hook with angular clearance around a longitudinal axis.

8. The device according to claim 1, wherein the flange is mounted in the body of the hook via a cylindrical spacer with a longitudinal axis pivotally received in an orifice of the hook, a pin being fastened across the spacer through an aperture of the body opening transversely into the orifice, two opposite edges of the aperture defining clearance stops by contact with the pin during pivoting of the flange.

9. The device according to claim 1, wherein the device includes a clip for transversely immobilizing the hook relative to the crosspiece, the clip being intended to be fastened at least transversely on the crosspiece.

10. An assembly comprising a cladding panel, and at least one fastening device made according to claim 1, which includes at least two hooks which are arranged along an upper edge of the panel, against a rear face of the panel, the two hooks being intended to be hooked onto the same crosspiece.

11. The assembly according to claim 10,
wherein the device includes a clip for transversely immobilizing the hook relative to the crosspiece, the clip being intended to be fastened at least transversely on the crosspiece, and
wherein only one of the hooks of the fastening device includes a clip for transversely immobilizing the hook relative to the crosspiece, the other one of said hooks being configured to be hooked to the associated crosspiece free to slide in a transverse direction.
